(19) United States
(12) Patent Application Publication
(10) Pub. No.: US 2008/0217466 A1
(43) Pub. Date: Sep. 11, 2008

(54) AUXILIARY ON BOARD POWER SYSTEM FOR AN AIRCRAFT

(76) Inventor: Brij B. Bhargava, Santa Barbara, CA (US)

Correspondence Address: THE LAW OFFICE OF RICHARD S ERBE, P.O. BOX 418, 5380 SENECA PLACE, SIMI VALLEY, CA, 93062, US

(21) Appl. No.: 11/683,711

(22) Filed: Mar. 8, 2007

(51) Int. Cl. B64D 33/00

(52) U.S. Cl. 244/50

(57) ABSTRACT

An auxiliary on board power system for an aircraft provides the capability of taxiing the aircraft on the ground without using the main aircraft engine(s). The power system includes a small driver mounted on the aircraft. In one embodiment of the invention, the driver may be mounted at any desirable location on the aircraft and is designed to provide sufficient thrust to taxi the aircraft. Such a suitable system may be provided as original equipment to an aircraft or retrofitted to existing aircraft. In another embodiment of the invention, the driver includes a speed reducer with an output shaft to drive the wheels of one of the landing gear assemblies to provide power to taxi the aircraft. In a further embodiment of the invention, the auxiliary on board power system, in addition to the taxiing function, may be incorporated with an alternator to provide electrical power, an environmental control unit, and an emergency power units as desired.

### RELATED APPLICATIONS

Not applicable.

### BACKGROUND OF THE INVENTION

1. Field of the Invention

The present invention relates to the field of auxiliary or secondary power systems for aircraft and, in particular, to an auxiliary on board power system that provides the capability of taxiing an aircraft without having to start or use the main aircraft engine(s).

2. General Background and State of the Art

In modern aircraft, weight space, and costs are highly important, whether the aircraft is for commercial, private or military applications. It is known, for example, that up to 15% of the costs to operate an aircraft are typically spent while the aircraft is on the ground. Conventional power systems that provide ground services for environmental cooling, engine start, ground system check-out, and emergency power (often referred to as auxiliary power units and emergency power units), while necessary, are also considered somewhat of a burden, as they generally only add weight to the aircraft while it is in flight. Thus, a reduction in parts, weight and complexity in such systems is considered highly desirable. Reliability and maintainability of aircraft systems are also very important issues, since they impact the availability of the aircraft and overall costs.

Secondary power systems have been integrated in aircraft that meet the aforementioned criteria. The integration of an auxiliary power unit (APU), emergency power unit (EPU), environmental control system (ECS) and engine start system (ESS) with reduced weight and size are known and are disclosed in a number of United States patents, such as U.S. Pat. No. 4,684,081 (Cronin), U.S. Pat. No. 5,235,812 (Klaass et al.), U.S. Pat. No. 5,309,029 (Gregory et al.), U.S. Pat. No. 5,408,821 (Romero et al.), and U.S. Pat. No. 5,490,645 (Woodhouse). Such systems include the capabilities of providing power for ground check-out, ground cooling, main engine start, flight cooling, and emergency engine start.

However, all such existing on board power systems, while providing many essential functions, do not provide the capability of taxiing the aircraft on the ground between the gate, hangar, or maintenance area to the runway and back without having to use the main engine(s). Such a power system would provide distinctive advantages to the aircraft owner and an airport, such as reduced fuel consumption, lowered emissions, lower noise levels, lower maintenance, and less wear (and thus longer useful life) of the main engine(s). The need for such a system is especially great at busy airports where aircraft frequently spend extended times at a gate or on runways with its main engine(s) running.

Another problem associated with conventional APU's is that they are located at the tail of the aircraft, well away from the majority of the electrical loads.

A power system, such as the power system according to the present invention, that would provide the capability of taxiing an aircraft without using the main aircraft engine(s) would preferably be small in size and weight, highly reliable, low cost, require minimum changes to existing aircraft systems, be used for power generation during flight (rather than being just additional dead weight), be readily integrated with existing aircraft systems and could make existing on board auxiliary power systems unnecessary or redundant. Such a system would also help to offset the low utilization factor problems of conventional auxiliary power and emergency power units. Additionally, such a system could provide redundancy and/or additional power to the aircraft if necessary.

It would be desirable, therefore, if a novel on board power system for taxiing an aircraft without having to use the main engine(s) could be provided and that could be easily retrofitted to an existing aircraft or be integrated with the systems on a new aircraft. It would also be desirable if such a system could be conveniently located on the aircraft close to the majority of the electrical loads. The inventor is unaware of any such system(s) available to the aircraft industry today.

### SUMMARY OF THE INVENTION

It is therefore an object of the present invention to provide an on board power system for taxiing an aircraft without the need for using the main aircraft engine(s) that can be readily retrofitted for use with existing aircraft.

It is a further object of the present invention to provide an on board power system for taxiing an aircraft without the need for using the main aircraft engine(s) that can be provided as standard equipment on new aircraft.

It is another object of the present invention to provide an on board power system for taxiing an aircraft without the need for using the main aircraft engine(s) that is small in size and light in weight.

It is a further object of the present invention to provide an on board power system for taxiing an aircraft without the need for using the main aircraft engine(s) that is high in efficiency and reliability.

Yet another object of the present invention is to provide an on board power system for taxiing an aircraft without the need for using the main aircraft engine(s) that is low in cost.

Another object of the present invention is to provide an on board power system for taxiing an aircraft without the need for using the main aircraft engine(s) that will reduce the overall fuel consumption of an aircraft.

Still another object of the present invention is to provide a power system for taxiing an aircraft without the need for using the main aircraft engine(s) that will require minimum changes and impacts to existing power systems on the aircraft.

It is yet another object of the present invention to provide a power system for taxiing an aircraft without the need for using the main aircraft engine(s) that will lower the overall level of noise emissions.

A further object of the present invention is to provide a power system for taxiing an aircraft without the need for using the main aircraft engine(s) that will result in lowered emissions of undesirable gases and solids to the atmosphere.

Another object of the present invention is to provide a power system for taxiing an aircraft without the need for using the main aircraft engine(s) that may be easily integrated with existing auxiliary power units and may make such units unnecessary and offset the low utilization factor problems of conventional auxiliary power and emergency power units.

A further object of the present invention is to provide a power system for taxiing an aircraft without the need for using the main aircraft engine(s) that may be located in a convenient location near the majority of the electrical loads of the aircraft.

Still another object of the present invention is to provide a power system for taxiing an aircraft without the need for using the main aircraft engine(s) that could provide redundancy with other aircraft systems.

It is yet another object of the present invention to provide a power system for taxiing an aircraft without the need for using the main aircraft engine(s) that can provide additional power to the aircraft if necessary.

These and other objectives are achieved by the present invention, which, in a broad aspect, provides a power system having a driver mounted on one of the landing gear of an aircraft that drives a speed reducer, for example, a gear box, whose output shaft is connected to the wheels of the aircraft. The driver and speed reducer provide sufficient power to drive the wheels and taxi the aircraft while it is on the ground, without having to operate the main aircraft engine(s).

A power system according to a preferred embodiment of the present invention includes an electronic control system and control panel in the aircraft that provides starting power to the driver, and may also provide primary and emergency power to the aircraft. The driver in the system according to a preferred embodiment of the invention may be a small turbine engine or a small internal combustion engine, such as a piston engine. A small turbine engine with a geared output power shaft may be installed on an existing aircraft to provide sufficient shaft horsepower to drive the aircraft wheels for taxiing. Such a turbine engine/geared output shaft combination, provides a substantial advantage in weight reduction over the piston engine. For example, the total dry weight of an approximately 400 horsepower aerospace qualified turbine engine with a gear box (around 6000 rpm shaft) is only about 160 pounds. Such a system is light weight, highly reliable, and could be modified and made adaptable to existing aircraft, or provided as standard equipment on new aircraft.

Alternatively, the driver may be a small piston engine, for example, to provide the taxiing capability. For example, an existing aerospace qualified 150 to 400 horsepower engine weighing less than 400 pounds may be utilized for this configuration. Such a modified system would satisfy the requirements of low cost, light weight and adaptability of the system to existing aircraft.

In an alternative embodiment of the invention, a driver, such as a small turbine engine, may be mounted on a landing gear and modified to include a high speed starter/generator on a high speed power shaft and a low speed output shaft from a speed reducer attached to the driver to drive the wheels of the landing gear to provide taxiing capability. The starter/generator could also be used in conjunction with a conventional environmental control unit. This embodiment of the invention could replace the conventional auxiliary aircraft power units as disclosed in Cronin, Klaass et al., Gregory et al., Romero et al., and Woodhouse, by providing all or any combinations of the same functions that those units provide. Additionally, such a system could be integrated to supplement and/or provide additional electrical power or designed to provide added redundancy if necessary.

In yet another embodiment of the invention, a driver, such as a turbine engine, may be mounted at any desirable location on the aircraft to provide sufficient thrust for taxiing the aircraft.

Further objects and advantages of this invention will become more apparent from the following description of the preferred embodiment, which, taken in conjunction with the accompanying drawings, will illustrate, by way of example, the principles of the invention.

### BRIEF DESCRIPTION OF THE DRAWINGS

The foregoing and other aspects and advantages will be better understood from the following detailed description of the preferred embodiments of the invention with reference to the drawings in which:

FIG. 1A is a front view of an aircraft illustrating where a preferred embodiment of an on board auxiliary power system according to the present invention may be located;

FIG. 1B is a bottom view of an aircraft on which a preferred embodiment of an on board auxiliary power system according to the present invention may be located;

FIG. 1C is a side view of an aircraft illustrating where a preferred embodiment of an on board auxiliary power system according to the present invention may be located;

FIG. 2 is a schematic diagram illustrating a preferred embodiment of an on board auxiliary power system in accordance with the present invention;

FIG. 3 is a schematic diagram illustrating a second embodiment of an on board auxiliary power system in accordance with the present invention; and

FIG. 4 is a schematic diagram illustrating a third embodiment of an on board auxiliary power system in accordance with the present invention.

### DETAILED DESCRIPTION OF THE PREFERRED EMBODIMENTS OF THE INVENTION

In the following description of the invention, reference is made to the accompanying drawings, which form a part thereof, and in which are shown, by way of illustration, exemplary embodiments illustrating the principles of the power system of the present invention and how it may be practiced. It is to be understood that other embodiments may be utilized to practice the present invention and structural and functional changes may be made thereto without departing from the scope of the present invention.

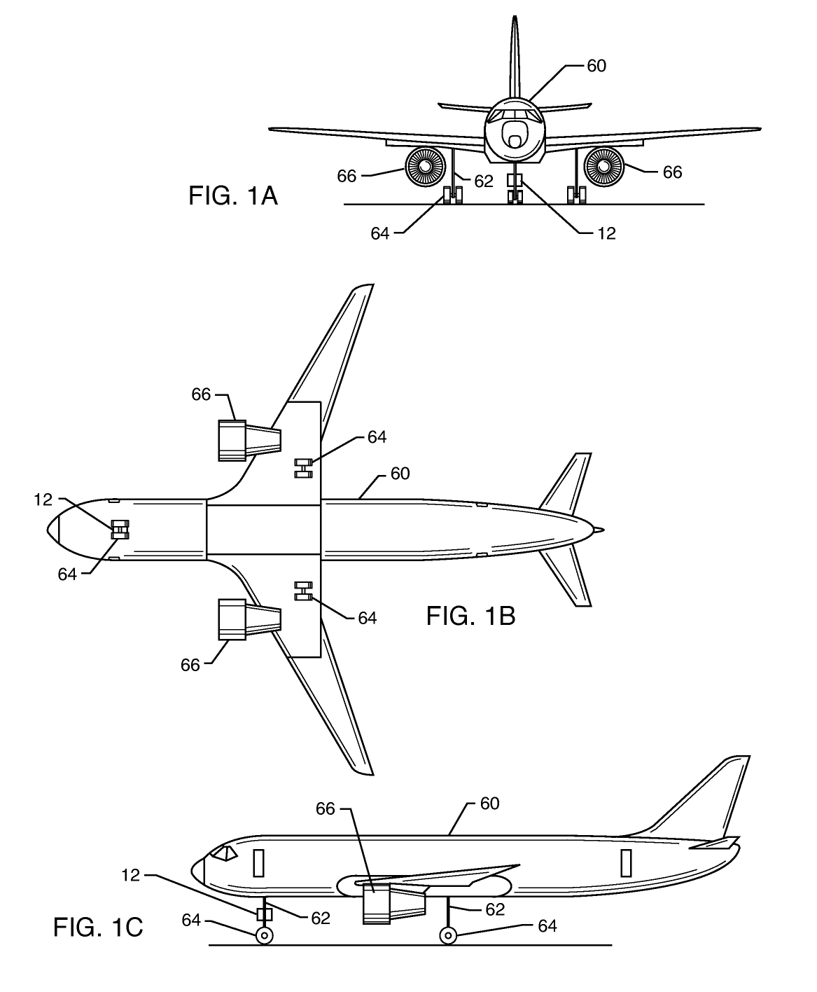

A power system according to the present invention is disclosed in several embodiments generally indicated by the numeral 10 and may be located on an aircraft 60 in various locations on the aircraft, as illustrated in FIGS. 1A-1C. One preferred location is on one of the landing gear 62, on which are included wheels 64. The purpose of the power system according to the present invention is to provide taxiing of aircraft 60 without having to operate the main aircraft engine(s) 66.

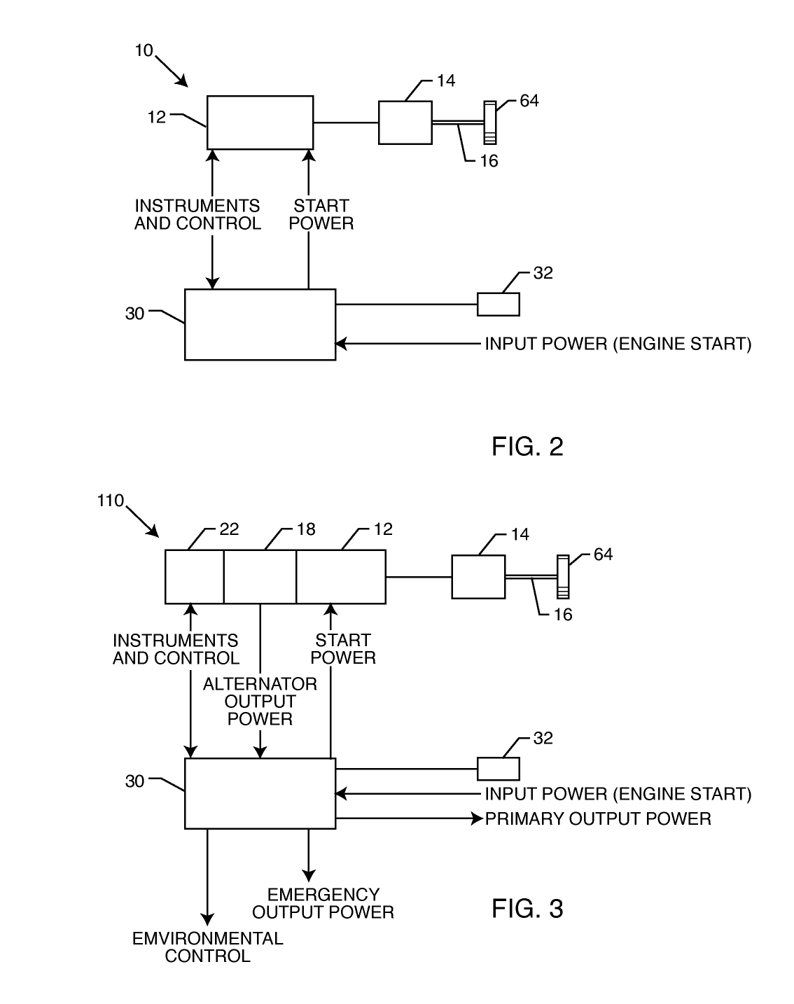

FIG. 2 schematically illustrates a preferred embodiment of a power system 10 in accordance with the present invention. Power system 10 includes driver 12, which may be an internal combustion engine or a turbine engine, for example, connected to speed reducer 14. Speed reducer 14 might be, for example, a gearbox. Output shaft 16 of speed reducer 14 is mechanically linked to power the wheels 64 of one of the aircraft landing gear and provides output power for moving the wheels and taxiing aircraft 60 without having to start the main flight engine(s) 66 of the aircraft.

Driver 12 is in electronic communication with control system 30, which also includes control panel 32 having the appropriate instrumentation, controls, indicator lights, and switches typical of such systems. Such control systems are well-known and quite common to those having skill in the art and the details of such a control system need not be discussed here. Also, the design of turbine engines, APU'S, EPU'S, ECS'S, ECS's, gearboxes and engine mounting structures are also well-known and quite common to those having skill in the art and the details of such systems, equipment and structures need not be discussed here. In the preferred embodiment of the invention, control system 30 provides starting power to driver 12 as well as primary output power and emergency output power to the aircraft. The preferred embodiment of power system 10 may be retrofitted to existing aircraft to provide sufficient shaft horsepower to wheels 64 to provide taxiing capability. This embodiment of a power system provides taxiing capability while being small in size and weight, highly efficient, highly reliable, low cost, low in fuel consumption, lower in emissions to the environment and low in maintenance. Such a system, retrofitted to an existing aircraft, would require minimal changes to existing aircraft systems. Such a system could also be provided as standard equipment on new aircraft.

Driver 12 in the preferred embodiment of power system 10 may be a small piston engine of approximately 150 hp to 400 hp depending on the size and weight of the aircraft and would likely add less than 400 pounds in weight. Such qualified engines for aerospace applications are generally highly reliable and would need very minor modifications to meet the requirements of the auxiliary power system of the present invention.

Alternatively, driver 12 may also be a small turbine engine that produces sufficient power to drive the wheels 64 to provide taxiing capability. Such an engine is highly reliable and, in combination with a speed reducer, would add only about 160 pounds to the aircraft weight.

FIG. 3 illustrates schematically a second embodiment of power system 10. Such a power system could be located at a similar location or locations on aircraft 60 as would the power system of the preferred embodiment of the invention.

In this embodiment of the invention, power system 10 includes driver 12, which would be designed to have a high speed power shaft (not shown) and a low speed geared power shaft (not shown). A high-speed alternator 18 would be mounted on the high-speed power shaft. Alternator 18, as is well known in the art, may also act as a starter/generator. A speed reducer 14 is also mounted on driver 12 at the low speed shaft and its output is mechanically linked to power the wheels 64 of aircraft 60. Alternator 18 may be used in conjunction with an environmental control unit 22, which provides conditioned air where required in various compartments of the aircraft.

Driver 12 is in electronic communication with control system 30, which also includes control panel 32 having the appropriate instrumentation, controls, indicator lights, and switches typical of such systems. As has been previously discussed, such control systems are well known and quite common to those having skill in the art and the details of such a control system need not be discussed here. Also as previously discussed, the design of turbine engines, APU's, EPU's, ECS's, ECS's, gearboxes and engine mounting structures are also well-known and quite common to those having skill in the art and the details of such systems, equipment and structures need not be discussed here. In this embodiment of the invention, control system 30 provides starting power to driver 12, and subsequently, primary output power and emergency output power to aircraft 60. This alternative embodiment of the auxiliary power system 10 may be retrofitted to existing aircraft to provide sufficient shaft horsepower to the wheels 64 to provide taxiing capability. This embodiment of a power system provides taxiing capability while being small in size and weight, highly efficient, highly reliable, low in cost, low in fuel consumption, lower in emissions to the environment and low in maintenance. Such a system, retrofitted to an existing aircraft, would require minimal changes to existing aircraft systems. Such a system could also be provided as standard equipment on a new aircraft.

Driver 12 in this embodiment of the invention may be a piston engine or a modified turbine engine with the alternator 18 being a high speed alternator, with a desired output, for example, of 30 to 120 kVA. The combination of driver 12, alternator 18, speed reducer 14 (which may be a gear box) for low speed and the associated controls, would likely add less than 600 pounds of weight to the aircraft. Several types of engines exist from which a suitable one may be chosen and modified as a driver to provide a light weight, reliable, low maintenance, low fuel consumption, low noise, low cost, and low emissions system. Such a power system 10 could eventually replace or render unnecessary conventional auxiliary power units, thereby further reducing the total weight and number of parts of the conventional systems in an aircraft. Additionally, such a system could be integrated to supplement and/or provide additional electrical power or designed to provide added redundancy if necessary.

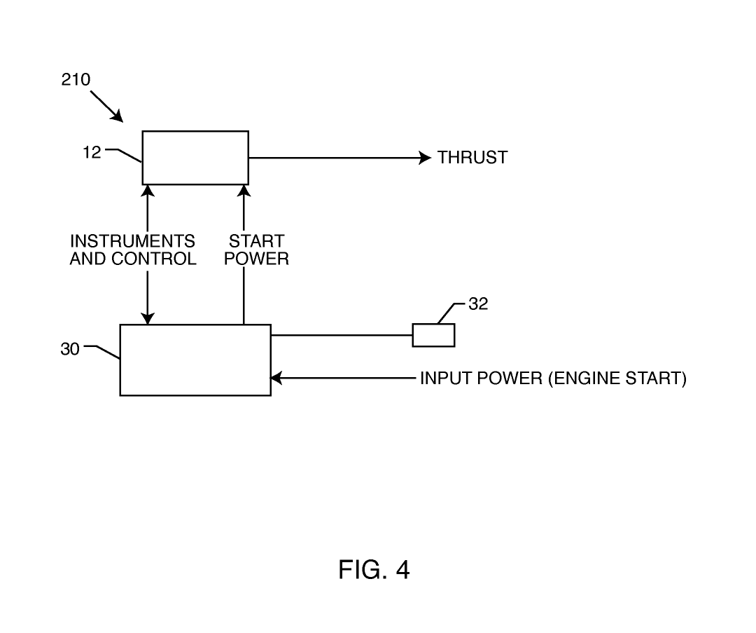

FIG. 4 schematically illustrates a third embodiment of a power system 10 to provide taxiing of aircraft 60, without having to use the main aircraft engine(s) 66. In this embodiment of the invention, driver 12 may be mounted to aircraft 60 in any of several convenient locations. Such a power system 10 could be readily retrofitted to existing aircraft and would generate sufficient thrust that would enable the driver to provide taxiing of the aircraft 60 without having to start the main engines 66 of the aircraft. Driver 12 may be a small turbine engine that provides sufficient thrust, which will depend on the requirements of the aircraft. Such a thrust engine in most applications would likely weigh less than 120 pounds and may be the lowest cost power system to provide taxiing capability, for existing or new aircraft.

Driver 12 is in electronic communication with control system 30, which also includes control panel 32 having the appropriate instrumentation, controls, indicator lights, and switches typical of such systems. As has been previously discussed, such control systems are well known and quite common to those having skill in the art and the details of such a control system need not be discussed here. Also as previously discussed, the design of turbine engines, APU's, EPU's, ECS's, ECS's, gearboxes and engine mounting structures are also well-known and quite common to those having skill in the art and the details of such systems, equipment and structures need not be discussed here. In this embodiment of the invention, control system 30 provides starting power to driver 12.

The foregoing description of exemplary embodiments of the present invention have been presented for purposes of enablement, illustration, and description. They are not intended to be exhaustive of or to limit the present invention to the precise forms discussed. There may be, however, other power systems not specifically described herein, but with which the present invention is applicable. The present invention should therefore not be seen as limited to the particular embodiments described herein; rather, it should be understood that the present invention has wide applicability with respect to the on board power systems for aircraft. Such other configurations can be achieved by those skilled in the art in view of the description herein. Accordingly, the scope of the invention is defined by the following claims.

1. An on board power system for an aircraft having landing gear and wheels and one or more main aircraft engine(s) for powering flight, said power system providing the capability to taxi the aircraft without having to use any of said one or more main aircraft engine(s), the power system comprising:
a driver mounted on the aircraft;
a driver control system in communication with said driver; and
a speed reducer connected to said driver, said speed reducer having an output shaft mechanically linked to power at least one of the wheels of the landing gear.

2. The power system according to claim 1, wherein said driver is a turbine engine.

3. The power system according to claim 1, wherein said driver is an internal combustion engine.

4. The power system according to claim 1, wherein said power system additionally provides the capability to start the on board power system.

5-10. (canceled)

11. An on board multifunction power system for an aircraft, the aircraft having landing gear and wheels, one or more main aircraft engine(s) for powering flight, said power system providing the capability to taxi the aircraft without having to use any of said one or more main aircraft engine(s), and at least one compartment requiring conditioned air, the power system comprising:
an electronic control system in said aircraft;
a driver mounted on the aircraft, said driver in communication with said control system;
a speed reducer connected to said driver, said speed reducer having an output shaft mechanically linked to power at least one of the wheels of said landing gear; and
an alternator connected to said driver and in electronic communication with said electronic control system.

12. The power system according to claim 11, wherein said driver is a turbine engine.

13. The power system according to claim 11, wherein said driver is an internal combustion engine.

14. The power system according to claim 11, wherein said power system provides electrical power.

15. The power system according to claim 11, wherein said power system additionally provides the capability of engine start to start the on board power system.

16. The power system according to claim 11, wherein said power system additionally provides the capability of emergency power.

17. The power system according to claim 11, wherein said power system additionally provides the capability of environmental control.

18. An on board power system for an aircraft having one or more main aircraft engine(s) for powering flight, said power system providing the capability to taxi the aircraft without having to use any of said one or more main aircraft engine(s), the power system comprising:
a driver mounted on the aircraft to provide thrust for taxiing; and
a driver control system in the aircraft in communication with said driver.

19. The system according to claim 18, wherein said driver is a turbine engine.

20. The system according to claim 11, wherein said power system additionally provides any combination of the following functions:
electrical power;
emergency power; and
environmental control.
